(19) United States
(12) Patent Application Publication
(10) Pub. No.: US 2009/0278365 A1
(43) Pub. Date: Nov. 12, 2009

(54) Pet dog clean-up poo scooper

(76) Inventor: Arlen Hawks, Vancouver (CA)

Correspondence Address: Kenneth R. Rice, 4110 N. 17th Street, Arlington, VA, 22207-3005, US

(21) Appl. No.: 12/453,378

(22) Filed: May 8, 2009

Related U.S. Application Data
(60) Provisional application No. 61/126,839, filed on May 8, 2008.

(51) Int. Cl. A01K 29/00

(52) U.S. Cl. 294/1.3

(57) ABSTRACT

The Pet Dog Clean-Up Poo Scooper is a new and improved container to provide for easy, one handed collection of animal waste. The container is easily opened to the use configuration. It is designed for one handed operation to scoop up the animal waste. The container may be reopened to collect additional waste prior to disposal. The container is provided with a cover which wraps over the container opening and around the contain to be connected near the closed end of the container. The collection is environmental friendly in its construction and disposal. It made of paper board with a composition of up to 70% post consumer waste paper. The container is 100% biodegradable. It is compact and easy to carry. In its folded state the container is about 5 inches long, 4¼ inches wide, and 1/16^{th} inches thick. It is easy to carry in a pocket or a holster clipped to a pet leash.

### BACKGROUND OF THE INVENTION

This invention relates, in general, to animal waste cleanup, and, in particular, to a novel container for the collection and disposal of animal waste.

### DESCRIPTION OF THE PRIOR ART

In the prior art various types of devices have been proposed.

U.S. Pat. No. 4,974,893 to Grahn shows an animal waste recovery and disposal kit. One uses a scoop to push the animal waste into a paper bag, which can then be sealed shut with a flap.

U.S. Pat. No. 5,037,149 to Beck shows an animal waste collector mad of a plastic bag with two stiffener ribs. The ribs form a triangular opening for picking up animal waste.

U.S. Pat. No. 6,611,961 to Deneur et al. shows a plastic glove for picking up animal waste. Once the waste is retrieved, the glove is inverted to form a disposable bag for the waste.

U.S. Pat. No. 5,725,268 to Besasie et al. is a plastic bag with a tray on one end. The bag is used as a glove to pick up the animal waste with the tray portion, then the bag is inverted to enclosed the waste filled tray for disposal.

In addition to the above cited patents, many other devices for collecting and disposing animal waste are known in the prior art. Many of them use extra hardware sure as handles, scoops, bag holders, etc., to collect the animal waste. They require the pet owner to carry these items with as they exercise their pets.

### SUMMARY OF THE INVENTION

The present invention is directed to a novel container for the collection and disposal of animal waste.

It is an object of the present invention to provide a new and improved container to provide for easy, one handed collection of animal waste. The container is easily opened to the use configuration. It is designed for one handed operation to scoop up the animal waste.

It is an object of the present invention to provide a new and improved container for the collection of animal waste that may be reopened to collect additional waste prior to disposal. The container is provided with a flap which wraps over the container opening and around the container to be fastened near the closed end of the container.

It is an object of the present invention to provide a new and improved container for the collection of animal waste that is environmental friendly in its construction and disposal. The container is made of paper board with a composition of up to 70% post consumer waste paper. The container is 100% biodegradable, compostable and completely disposable.

It is an object of the present invention to provide a new and improved container for the collection of animal waste that is compact and easy to carry. In its folded state the container is preferably about 5 inches long, 4¼ inches wide, and 1/16^{th} inches thick. It may be made in larger or smaller sizes as its intended use dictates. It is easy to carry in a pocket or a holster clipped to a pet leash or belt.

These and other objects and advantages of the present invention will be fully apparent from the following description, when taken in connection with the annexed drawings.

### BRIEF DESCRIPTION OF THE DRAWINGS

FIG. 1 is a plan view of the container prior to being assembled.

FIG. 2 is a side view of the container with the flap open.

FIG. 3 is a side view of the contained with the flap closed.

FIG. 4 is a view of the container being used.

### DESCRIPTION OF THE PREFERRED EMBODIMENT

The preferred embodiment herein described is not intended to be exhaustive or to limit the invention to the precise form disclosed. It is chosen and described to best explain the invention so that others, skilled in the art to which the invention pertains, might utilize its teachings.

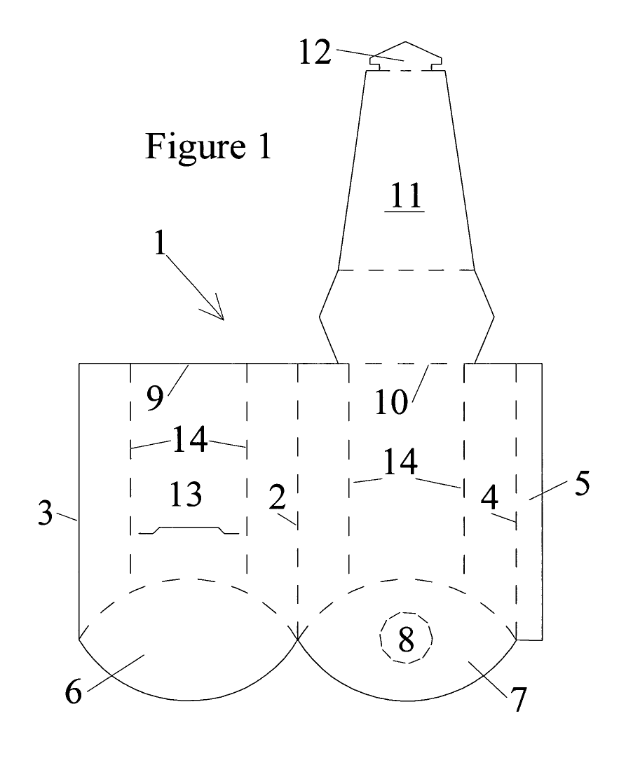

Referring now to the drawings in greater detail, FIG. 1 shows a plan view of the container in an unassembled state. The container 1 is made from a single piece of paper board. The paper board is preferably made of 70% post consumer waste paper to allow the container to be 100% recyclable. The container is folded at the central fold line 2 to bring left edge 3 in alignment with right edge 4. Edge flap 5 on right edge 4 is folded over left edge 3 and glued into place. Alternatively, the edge flap 5 may be held in place by a strip of single or double sided tape. The bottom has two almond or oval shaped flaps, the first bottom flap 6 and the second bottom flap 7. Bottom flap 7 is optionally provided with a pressure sensitive glue spot, or may be held in place by a strip of single or double sided tape. The container opening is formed of the two top edges 9, 10. A cover 11 is provided by an elongate tongue extending from the top edge 10. The cover has a lower portion which is sized and shaped to cover the open end of the container. The cover has a locking tab 12 which will mate with a slot 13 near the bottom flap 6, is Alternatively, the cover may be provided with a pressure sensitive glue spot, or may be held in place by a strip of single or double sided tape.

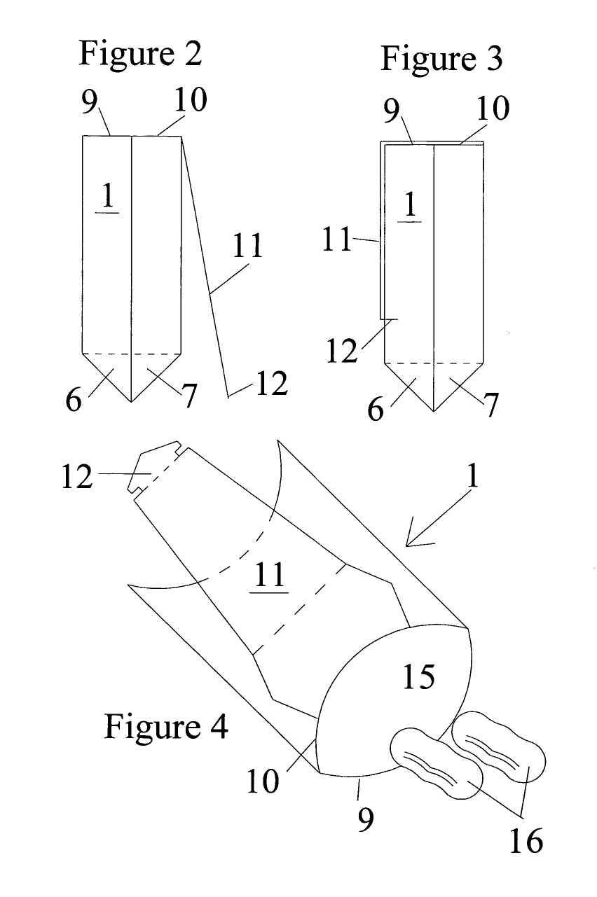

The unused container 1 is provided in a flat configuration. To use the container, the user squeezes the sides 2, 3-4 together to form a tube. Optional crease lines 14 may be provided to facilitate the forming of the tube. The first bottom flap 6 is folded into the tube opening. Then the second bottom flap 7 is folded over the first bottom flap 6. This will form a cup like container. FIG. 2 shows a side view of the container 1 in its ready to use configuration. FIG. 3 show the container 1 in its after use configuration with the paper cover 11 wrapped around the container 1 and the tab 12 inserted in the slot 13.

FIG. 4 shows the container in use. The user squeezes the sides 2, 3-4 together to form an opening 15 between the top edges 9, 10. The animal waste 16 is scooped into the container 1, which is then allowed to close. The cover 11 is then wrapped around the container 1 as shown in FIG. 3, and the tab 12 inserted into slot 13. The side of the container opposite the flap is towards the ground, and may become soiled by the action of picking up the animal waste. The cover 11 will cover that soiled area should it become soiled. The tab 12 may be removed from the slot 13 should additional animal waste 16 needed to be collected. The closed container 1 in FIG. 3 may be disposed of in any waste receptacle.

In addition to being used to recover and dispose of animal waste, the container may be used for other purposes such as carrying a snack or other comestible, or other consumer oriented product.

Although the Pet Dog Clean-Up Poo Scooper and the method of using the same according to the present invention has been described in the foregoing specification with considerable details, it is to be understood that modifications may be made to the invention which do not exceed the scope of the appended claims and modified forms of the present invention done by others skilled in the art to which the invention pertains will be considered infringements of this invention when those modified forms fall within the claimed scope of this invention.

1. A scoop for cleaning up animal waste comprising:
a paper board blank formed of two sidewall panels,
an edge flap along one side edge of one of side panels, said edge flap being connected to the opposite side edge of the other of side panels to form a container,
the bottom edge of said each side panel being downwardly curved, with an upwardly curved fold line aligned with the downwardly curved bottom edge to form two oval shaped bottom flaps,
the bottom flap of each side panel being folded along said curved fold line after the container is formed to create the shape of a pillow box,
the top edge of the side panels forming an opening in which to collect animal waste by a scooping motion,
an elongate tongue extending from the top edge of one side panel, the bottom portion of side tongue providing a cover for the top opening of the container and the top portion of the tongue connectable near the bottom edge of the second side panel.

2. The scoop as claimed in claim 1, wherein said edge flap being connected by glue to the opposite side edge of the other of side panels to form a container.

3. The scoop as claimed in claim 1, wherein said edge flap being connected by tape to the opposite side edge of the other of side panels to form a container.

4. The scoop as claimed in claim 1, wherein one of said bottom edge flaps is provided with a glue spot which seals it to the other of said bottom edge flaps.

5. The scoop as claimed in claim 1, wherein said bottom edge flaps are held together by tape.

6. The scoop as claimed in claim 1, wherein the top portion of the tongue has a tab which is insertable into a slot near the bottom edge of the second side panel.

7. The scoop as claimed in claim 1, wherein the top portion of the tongue is connected by glue near the bottom edge of the second side panel.

8. The scoop as claimed in claim 1, wherein the top portion of the tongue is connected by tape near the bottom edge of the second side panel.

9. The scoop as claimed in claim 1, wherein the paper board blank has a composition of up to 70% post consumer waste paper.

10. A method of cleaning up animal waste comprising,
using a container having two sides joined together, two oval shaped bottom flaps and an 13 cover formed by an elongate tongue,
squeezing the sides together and folding in the two oval shaped bottom flaps to form the container,
scooping the animal waste into the container,
wrapping the cover around the container,
connecting the cover near the bottom edge of the side of the container, and
disposing of the container.

11. The method of cleaning up animal waste as claimed in claim 10, wherein said cover
has tab, and the side of the contain has a slot,
the step of connecting the cover near the bottom edge of the side of the container includes inserted the tab into the slot.

12. The method of cleaning up animal waste as claimed in claim 10, wherein
the step of scooping the animal waste into the container includes touching the side of the container to the ground in a manner that it becomes soiled, and
the step of wrapping the cover around the container includes placing the cover over the soiled are to prevent it from being touched.

13. The method of cleaning up animal waste as claimed in claim 10, wherein upon being
presented with a need to collect additional animal waste,
disconnecting the cover from the side of the container,
scooping the additional animal waste into the container,
rewrapping the cover around the container,
reconnecting the cover near the bottom edge of the side of the container, and
disposing of the container.
